(19) United States
(12) Patent Application Publication
(10) Pub. No.: US 2018/0035636 A1
(43) Pub. Date: Feb. 8, 2018

(54) A THERAPEUTIC BED

(71) Applicant: Michelle Louise CUMMINS, Queensland (AU)

(72) Inventor: Michelle Louise CUMMINS, Queensland (AU)

(21) Appl. No.: 15/549,030

(22) PCT Filed: Feb. 16, 2016
(86) PCT No.: PCT/AU2016/050073

§ 371 Date: Aug. 4, 2017

(30) Foreign Application Priority Data
Feb. 6, 2015 (AU) 2015900374

(51) Int. Cl. A01K 1/035; B32B 5/14; A61G 7/05

(52) U.S. Cl. CPC A01K 1/0353; A61G 7/05; B32B 5/14; A47C 27/00

(57) ABSTRACT

The present invention relates generally to a therapeutic bed for use by an animal where recovery is promoted or accelerated by a prolonged retention or increase in the animal's body temperature. The bed comprises a matrix of fibres between a sealed top and a sealed bottom surface where the arrangement of the fibres gradually increases from an upper, less dense region adjacent the top surface to a lower, denser region in the matrix. The matrix arrangement is adapted to absorb the animal's body heat through the top surface and to transfer the body heat absorbed by the less compacted fibres of the upper, less dense region to the denser lower compacted fibres. The heat stored by the denser lower compacted fibres is gradually released and returned to the less dense fibres of the upper, less dense region to be slowly reradiated back to the animal.

### FIELD OF THE INVENTION

The invention relates to health and therapeutic apparatus, in particular to a therapeutic bed used in the treatment of osteoarthritic and other heat responsive conditions wherein recovery is promoted or accelerated by a prolonged retention or increase in body temperature.

Most particularly, the present invention relates to a heat reradiating therapeutic bed, which supports the joints and muscles of an animal in recovery, whereby the bed provides a controlled level of warmth to the animal to facilitate recovery.

While the invention is primarily directed to veterinary application, it is obvious that persons with certain conditions may also benefit from its use.

### BACKGROUND OF THE INVENTION

The treatment of osteoarthritic and other heat responsive conditions wherein recovery is promoted or accelerated by a prolonged retention or increase in body temperature is known.

Products used in the prior art include heat ray lamps, hot water bottles, pre heated bean bags and the like. In all these devices, there is some effort or energy required to maintain heat output in prolonged treatment. In the case of veterinary application, it is often difficult to get an animal to lay down in a particular position for any length of time. Warming devices such as hot water bottles also lose their effectiveness as the night progresses especially in winter.

While there are prior art therapeutic blankets and mattresses, most if not all lose their firmness over time and use due to their internal design. Use of materials such as mattress foams also tend to absorb moisture. This is a hazard especially where animals are concerned. Materials such as mattress foams and the like also do not provide corrective support to alleviate and reduce incorrect posture and to ensure correct alignment of joints and the skeletal system of an animal using conventional mattresses.

Further, the synthetic materials used in the manufacture of conventional therapeutic blankets and mattresses are also prone to the release of chemical residues which may have unhealthy side effects on a recovering animal. Natural fibre mattresses are safer but can lose their loft much earlier due to repeated compaction and also have the disadvantage of tending to harbour parasites such as fleas and/or lice.

Another disadvantage of conventional bedding, which contains polyester filling is that this synthetic filling doesn't ‘breathe’, and the heat generated by the animal resting on the bed is retained in the filling. As such, the bedding doesn't cool until the animal moves off the bed. This can be particularly problematic in relation to animals that do not sweat, where it may result in the animal overheating.

There is therefore a need of a therapeutic heat treatment apparatus or device which does not rely on an external power source and which does not include the disadvantages or limitations of the prior art.

### SUMMARY OF THE INVENTION

According to a first embodiment, the present invention relates to a therapeutic bed for use by an animal where recovery is promoted or accelerated by a prolonged retention or increase in the animal's body temperature comprising:

a matrix of fibres between a sealed top and a sealed bottom surface where the arrangement of the fibres gradually increases from an upper, less dense region adjacent the top surface to a lower, denser region in the matrix;
the matrix arrangement adapted to absorb the animal's body heat through the top surface and to transfer the body heat absorbed by the less compacted fibres of the upper, less dense region to the denser lower compacted fibres;
wherein the heat stored by the denser lower compacted fibres is gradually released and returned to the less dense fibres of the upper, less dense region to be slowly reradiated back to the animal.

Preferably, the top and bottom surfaces have different heat and sound insulating and reflective properties; the bottom surface of a higher rating than the top surface to promote heat transfer from the lower surface to the top surface and to reduce or prevent heat loss and/or transfer of sound to the surface on which the bed is placed.

Preferably, the fibres carded thermally bonded nonwoven polyester fibres that are non-hazardous, non-flammable, non-toxic, non-allergenic, non-irritant, resistant to insect and vermin, not substantially affected by moisture and have a pH of about 7.8.

Most preferably, the fibres have a VOC concentration of 0.01 mg/m³ (7 days), have a Smoke Growth Rate Index (SMOGRARC) rating of less than 100 m²/s² and when exposed to an atmosphere of 50° C. at 90% relative humidity for four days showed moisture absorption by weight of less than 0.03%.

Preferably, the density of the upper, less dense region is one of 900 gsm or 1591 gsm, and the density of the lower, denser region is one of 1591 gsm or 4800 gsm. Most preferably, the density of the upper, less dense region is 900 gsm when the density of the lower, denser region is 1591 gsm; and the density of the upper, less dense region is 1591 gsm when the density of the lower, denser region is 4800 gsm.

Preferably, when the bed is in use, the density of the matrix of fibres supports the joints and aligns the spine of the animal.

Preferably, when the bed is in use, the arrangement of the fibres within the matrix reduces the incidence rate of pressure sores on the animal.

In one embodiment, the fibres are arranged in an integral or unitary matrix with compressibility gradually decreasing from the top surface to the bottom surface.

In an alternative embodiment, the matrix of fibres may be comprised of discrete and separate layers of fibres of increasing density or compaction from the top to the bottom surface.

The therapeutic bed preferably further includes a removable and washable outer fabric cover.

The therapeutic bed is preferably used for a veterinary application used in the treatment of animals, which most preferably includes the treatment of osteoarthritic and other heat responsive conditions.

### BRIEF DESCRIPTION OF THE DRAWINGS

In order that the invention be understood, reference is made to the accompanying drawings in which:

FIG. 1 shows a preferred embodiment of the therapeutic bed in accordance with the invention.

### DETAILED DESCRIPTION OF THE EMBODIMENTS

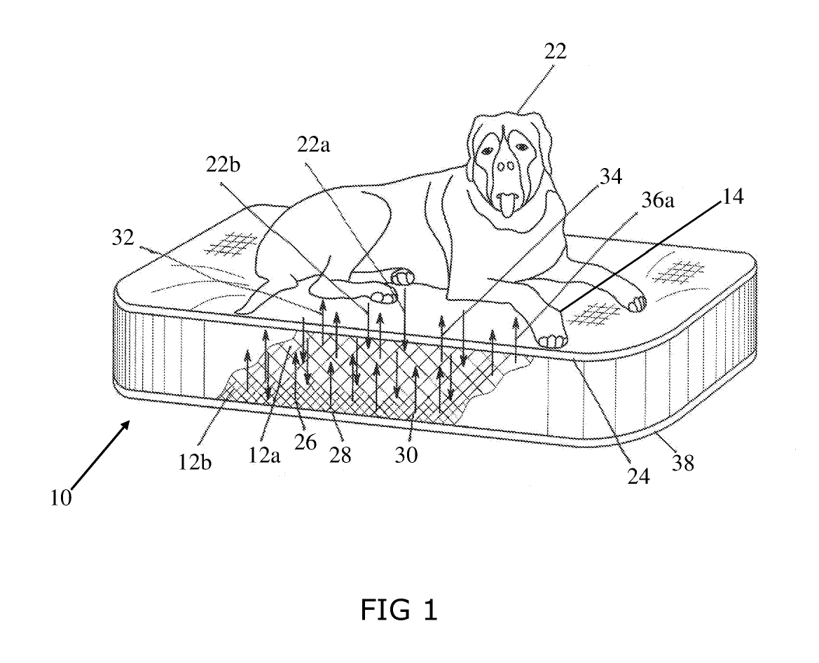

As shown in FIG. 1 the therapeutic bed 10 comprises a matrix of thermally bonded fibres 12 sealed between a sealed top and a bottom surface.

The density of the fibres gradually increases from an upper, less dense to a lower, denser compaction in the matrix. The arrangement is adapted to absorb body heat 22a, 22b when the animal 22 lays on the more comfortable and compliant top surface 24.

The matrix of thermally bonded fibres 12 is comprised of carded thermally bonded nonwoven polyester fibres. Whilst nonwoven polyester fibres are preferred for use with the present invention, other suitable nonwoven fabric fibres can also be utilised.

The polyester fibres of the matrix of thermally bonded fibres 12 are non-hazardous and are VOC emission safe, having a VOC concentration of 0.01 mg/m³ (7 days) and a certified limit of 0.25 mg/m³ (7 days) determined by Good Environmental Choice Australia (Cetec Pty Ltd—Report:RCV080408). Further, the polyester fibres are non-flammable, having a Smoke Growth Rate Index (SMOGRARC) rating of less than 100 m²/s² (Report No. FAR4045) and having an Ignitability Index (0-20) 0; a Heat Evolved Index (0-10) 0; Spread of Flame Index (0-10) 0 and a Smoke Developed Index (0-10) 3. Further, polyester fibres of the matrix are not affected by moisture. Exposure to an atmosphere of 50° C. at 90% relative humidity for four days showed moisture absorption by weight of less than 0.03%. The polyester fibres of the matrix have a pH of 7.8 and are non-toxic, non-allergenic, non-irritant and are naturally resistant to insect and vermin attack. The polyester fibres of the matrix are also preferably recycled and recyclable.

Material Data Sheet Details for the polyester fibres of the matrix of thermally bonded fibres 12 are as follows:

Chemical Entity: Polyester Fibre from
PET (Polyethylene Terephthalate)

| | |
|---|---|
| Odour: | No Odour |
| pH: | 7.8 (pH 7 being neutral) |
| Boiling Point: | N/A |
| Melting Point: | 250° C. |
| Max. Recommended Service Temp: | 160° C. |
| Vapour Pressure: | N/A |
| Specific Gravity: | Polyester 1.38 |
| Flash point: | N/A |
| Explosive limits: | N/A |
| Solubility in water: | Not soluble |
| Moisture Absorption: | less than 0.03% by weight |
| Relative Vapour Density: | N/A |
| PerCent Volatiles: | Nil |
| Corrosiveness: | Non-corrosive |

The matrix of thermally bonded fibres 12 is heat-pressed into a ‘slab’, which becomes the mattress of the therapeutic bed 10. The density of the ‘slab’ is controlled and is determined by the weight of the animal 22 for which the bed 10 is to be used. The density of the ‘slab’ is important because it controls the level of warmth that is retained and reradiated towards the animal. Furthermore, the density of the ‘slab’ is predetermined to assists in supporting the animal, and importantly assists the spine to remain straight when the animal is in recovery on the bed. This means that the spine and the supporting muscles are not overcompensating to restore the animal's balance, further assisting the animal's recovery process.

Body heat captured and retained by the upper less compacted fibres 12a is transferred by fibres of the denser more compacted portions 12b of the matrix wherein the heat 32, 34, 36 stored in the lower more compressed fibres is gradually released and returned to the upper less dense fibres and slowly reradiated back to the animal's body as a therapeutic treatment.

In an alternative embodiment, the matrix of fibres may be comprised of discrete and separate layers of fibres of increasing density or compaction from the top to the bottom surface. Preferably, the fibres are arranged in an integral or unitary matrix with a graded profile of decreasing compressibility from the top to the bottom surface in the interest of comfort during periods of prolonged treatment. In a less preferable alternative embodiment, the matrix of fibres may be comprised of discrete and separate layers of fibres of increasing density or compaction from the top to the bottom surface.

Whether the matrix of fibres is comprised of a single/unitary matrix in which the density of the fibres gradually increases from an upper, less dense to a lower, denser compaction in the matrix or the matrix is comprised of discrete and separate layers of fibres, the densities of the less dense and the more dense regions is optimized to facilitate the rehabilitation of the animal.

Whilst the specific densities can be changed to suit different animals, where the animal is small (e.g. less than 45 kgs), the optimal density of the less dense region is about 900 gsm and the optimal density of the denser region is about 1591 gsm. Where the animal is larger (e.g. greater than 45 kgs), the optimal density of the less dense region is about 1591 gsm and the optimal density of the denser region is about 4800 gsm.

Preferably, also the top 24 and bottom 38 surfaces are manufactured to have different heat and sound insulating and reflective properties wherein the bottom surface is of a higher “R” rating. This asymmetrical arrangement is to prevent or reduce heat loss and/or transfer of sound to the surface or floor on which the bed is placed while at the same time allowing heat retention and reradiating back to the animal. The differential in R rating also results in promoting the re-transfer of heat stored from the fibres adjacent the higher rated bottom surface towards the top surface rather than being lost through the bottom surface. Furthermore, suspended and wooden floors can be noisy surfaces especially with animals that tend to move around before settling or sleeping on their bedding. The reduction in noise as a consequence of the differentially insulated ratings will benefit not only the injured animal in its recovery by facilitating sound sleep but that of all residents in a building so affected.

As shown, the bed 10 includes a removable and washable outer fabric cover 40 which will also protect and prolong the life of the product. The fibres in the matrix are preferably of a material such as an inert closed cell polyester so that the absorption of moisture or release of chemical residues which may have an unhealthy effect on the animal are not an issue. As previously mentioned, the fibres may also be of a hollow or tubular configuration to further augment heat capture.

### Heat Profile

The ‘breathability’ of the matrix of thermally bonded fibres 12 allows for a controlled heat profile formed in the air surrounding the animal. The heat is initially generated by the body heat of the animal, but is retained and reradiated by the thermally bonded fibres 12. The animal's joints 14 are surrounded by this warmth, which keeps blood circulating and, in turn, promotes healing and prevents stiffness in the animal's joints.

### Pressure Sores

Further, the ‘breathability’ of the matrix of thermally bonded fibres 12 prevents pressure sores (also known as bed sores/pressure ulcers/decubitis ulcers) from occurring. There are two mechanisms that contribute to pressure ulcer development: (1) external pressure that compresses blood vessels and (2) friction and shearing forces that tear and injure blood vessels.

It has been observed that the therapeutic bed 10 of the present invention can reduce the external pressure applied over an area of the body of an animal, especially over the bony prominences, which can result in obstruction of the blood capillaries, depriving tissues of oxygen and nutrients, causing ischemia (deficiency of blood in a particular area), hypoxia (inadequate amount of oxygen available to the cells), edema, inflammation, and, finally, necrosis and ulcer formation.

In lame animals, particularly horses, pressure sores can likely develop within 24 hours. In one experiment of the therapeutic bed 10 of the present invention, the test animal (being a Great Dane dog weighing approximately 75 kg), was lame for 18 months following an operation on its spine. The dog could not walk at all, or even sit up. As part of the recovery process, the dog laid on a therapeutic bed 10 of the present invention for the entire 18 month recovery period, and was turned every three hours. The dog did not develop a single pressure sore in that time, which was observed as a first by the treating veterinarian.

### COMPARATIVE EXAMPLES

Several variations of beds were manufactured using several different conventional filling materials. The conventional filling materials were variations of polyester, wool and cotton. These were trialed in comparative tests with a bed of the present invention in which the filing was a matrix of thermally bonded fibres.

In the comparative tests, each of the beds were utilised with a male cat weighing approximately 3.5 kgs for a period of 3 months. During the trial, the usage patterns of each of the beds was observed and the amount of time spent by the cat on each bed, the cat's sleeping behaviour and the general level of interest shown by the cat for each of the beds was monitored and recorded.

The results of these Examples are discussed below:—
Polyester Filling Material: was ineffective in heat distribution, and required a significant amount of time (much longer than with the filling material of the present invention) to reflect/reradiate any warmth generated by the animal. Further, the warmth that was reflected/reradiated did not remain around the animal, instead it dissipated almost instantly. After one week of use, the polyester developed an odour. Although the animal (in this case being a cat of about 3.5 kgs) was not particularly heavy, the constant use of the bed over the course of the experiment, resulted in a ‘flattening out’ of the bed mattress.
Wool Filling Material: did absorb some warmth but only to a moderate temperature. Within one month fleas were visible within the wool fibres. The wool filling was very heavy when washed, and took several days to dry when the mattress was washed.
Cotton Filling Material: required a very large quantity of cotton fibres in order to provide the required density level, and even when the mattress was of a suitable thickness, the cotton filling material offered very little in the way of weight support for the animal. The cotton filling material did not wash well in so far as the positioning of the filing material was disturbed during the washing cycle such that the filing became thin in some areas, and bulky in some other areas. Further, the filing took many days to dry when the mattress was washed.
Matrix of Thermally Bonded Fibres Filling Material: was very effective in heat distribution. The warmth generated by the animal's body heat was concentrated where the bulk of the animal's body was in contact with the tope surface of the bed, and the heat dissipated and ‘evened out’ around the outer edges of the bed. The bed supported the sleeping posture of the animal and the fibres retained their shape without flattening after use by the animal.

### Heat Retention—Additional Heat Source

During the comparative examples, for all four beds, a further comparative test was conducted in which a pocket was sewn in to the underside of the bed to house a heat pad (which was a sack filled with rice). The heat pad was warmed in a microwave (30 seconds) and was then inserted into the pocket in order to provide additional warmth to the animal.

For the beds that were filled with conventional filling material (i.e. the polyester, the wool and the cotton), the heat pad once inserted into the pocket stayed warm no longer in those beds than where the heat pad was simply left sitting on its own, directly exposed to the environment (about 7 minutes). Any heat that was generated by the heat pad dissipated quickly and did not provide any significant level of heat re-radiation over and above the body heat of the animal. Further, the conventional filling materials appeared to ‘sweat’, which created moisture and over the course of the experiment, mold eventually grew on the calico material encasing the filling material.

For the bed that was filled with the matrix of thermally bonded fibres of the present invention, the heat pad once inserted into the pocket stayed warm, far longer than where the heat pad was simply left sitting on its own, directly exposed to the environment. As discussed above, the heat pad generally returned to ambient room temperature after about 7 minutes when directly exposed to the ambient environment.

Further, when the heat pad was used with the bed filled with the matrix of thermally bonded fibres of the present invention, the heat generated by the heat pad reradiated through the bed for a significant time, measured in terms of hours rather than minutes as with the convention filing materials.

It will of course be realized that while the foregoing has been given by way of illustrative example of this invention, all such and other modifications and variations thereto as would be apparent to persons skilled in the art are deemed to fall within the broad scope and ambit of this invention as is herein set forth.

In the specification the terms “comprising” and “containing” shall be understood to have a broad meaning similar to the term “including” and will be understood to imply the inclusion of a stated integer or step or group of integers or steps but not the exclusion of any other integer or step or group of integers or steps. This definition also applies to variations on the terms “comprising” and “containing” such as “comprise”, “comprises”, “contain” and “contains”.

1. A therapeutic bed for use by an animal where recovery is promoted or accelerated by a prolonged retention or increase in the animal's body temperature comprising:
a matrix of fibres arranged between a sealed top and a sealed bottom surface where the arrangement of the fibres gradually increases from an upper, less dense region adjacent the top surface to a lower, denser region in the matrix;
the matrix arrangement adapted to absorb the animal's body heat through the top surface and to transfer the body heat absorbed by the less compacted fibres of the upper, less dense region to the denser lower compacted fibres;
wherein the heat stored by the denser lower compacted fibres is gradually released and returned to the less dense fibres of the upper, less dense region to be slowly reradiated back to the animal.

2. A therapeutic bed of claim 1 wherein, the top and bottom surfaces have different heat and sound insulating and reflective properties; the bottom surface of a higher rating than the top surface to promote heat transfer from the lower surface to the top surface and to reduce or prevent heat loss and/or transfer of sound to the surface on which the bed is placed.

3. A therapeutic bed of claim 1 wherein, the fibres comprise carded thermally bonded nonwoven polyester fibres that are non-hazardous, non-flammable, non-toxic, non-allergenic, non-irritant, resistant to insect and vermin, not substantially affected by moisture and have a pH of about 7.8.

4. A therapeutic bed of claim 3 wherein, the fibres have a VOC concentration of 0.01 mg/m³ (7 days), have a Smoke Growth Rate Index (SMOGRARC) rating of less than 100 m²/s² and when exposed to an atmosphere of 50° C. at 90% relative humidity for four days showed moisture absorption by weight of less than 0.03%.

5. A therapeutic bed of claim 1 wherein, the density of the upper, less dense region is one of 900 gsm or 1591 gsm, and the density of the lower, denser region is one of 1591 gsm or 4800 gsm.

6. A therapeutic bed of claim 5 wherein, the density of the upper, less dense region is 900 gsm when the density of the lower, denser region is 1591 gsm; and the density of the upper, less dense region is 1591 gsm when the density of the lower, denser region is 4800 gsm.

7. A therapeutic bed of claim 1 wherein, the fibres are arranged in an integral or unitary matrix with compressibility gradually decreasing from the top surface to the bottom surface.

8. A therapeutic bed of claim 1 wherein, the matrix of fibres comprises discrete and separate layers of fibres of increasing density or compaction from the top to the bottom surface.

9. A therapeutic bed of claim 1 wherein, when the bed is in use, the density of the matrix of fibres supports the joints and aligns the spine of the animal.

10. A therapeutic bed of claim 1 wherein, when the bed is in use, the arrangement of the fibres within the matrix reduces the incidence rate of pressure sores on the animal.

11. A therapeutic bed of claim 1 further including a removable and washable outer fabric cover.

12. A therapeutic bed of claim 1 when used for a veterinary application used in the treatment of animals.

13. A therapeutic bed of claim 12 wherein, the veterinary application includes the treatment of osteoarthritic and other heat responsive conditions.
